(19) United States
(12) Patent Application Publication
(10) Pub. No.: US 2015/0100500 A1
(43) Pub. Date: Apr. 9, 2015

(54) BEST OFFER IMMEDIATE PAY FEATURE

(71) Applicants: Srinivasa Pasupulati, Cupertino, CA (US); Edward Tang, San Jose, CA (US); Yun Liu, Cupertino, CA (US); Shikha Khanna, Cupertino, CA (US); Louis Olson, Menlo Park, CA (US)

(72) Inventors: Srinivasa Pasupulati, Cupertino, CA (US); Edward Tang, San Jose, CA (US); Yun Liu, Cupertino, CA (US); Shikha Khanna, Cupertino, CA (US); Louis Olson, Menlo Park, CA (US)

(21) Appl. No.: 14/049,058

(22) Filed: Oct. 8, 2013

(51) Int. Cl. G06Q 30/06

(52) U.S. Cl. CPC G06Q 30/0611
USPC 705/80; 705/26.4

(57) ABSTRACT

A method of handling negotiations between a seller of an item and prospective buyers of the item is disclosed. A first offer for the item is received. The first offer includes a first item price and a first item quantity. A second offer for the item is received. The second offer includes a second item price and a second item quantity. It is detected that a first prospective buyer submitted a payment corresponding to the first offer before a second prospective buyer submitted a payment corresponding to the second offer. Based on an item quantity of the seller being less than the first quantity plus the second quantity, the seller is notified that the seller has an obligation to provide the first item quantity of the item to the first prospective buyer, but not the second quantity of the item to the second prospective buyer.

### TECHNICAL FIELD

The present application relates generally to the technical field of internet commerce, and, in one specific example, to.

### BACKGROUND

Various network-based publication systems (e.g., EBAY®, AMAZON®, or CRAIGSLIST®) may facilitate the buying or selling of items (e.g., goods or services) by their users. However, in various circumstances, a buyer may agree to buy an item from a seller via the network-based publication system, but then renege on the agreement. In these circumstances, the seller of the item may have to seek another buyer for the item, thus wasting time and resources of the seller. It may be beneficial to the owner of the network-based publication system and the sellers to minimize the chances that a buyer will renege on an agreement reached between the buyer and the seller via the network-based publication system.

### BRIEF DESCRIPTION OF THE DRAWINGS

Some embodiments are illustrated by way of example and not limitation in the figures of the accompanying drawings.

FIG. 1 is a network diagram depicting a client-server system within which various example embodiments may be deployed;

FIG. 2 is a block diagram illustrating multiple applications including best offer applications that, in various example embodiments, are provided as part of the networked system of FIG. 1;

FIG. 3 is a block diagram illustrating example modules of the best offer application(s) of FIG. 2;

FIG. 4 is a sequence diagram illustrating an example sequence of steps of a transaction initiated on a network-based publication system between a prospective buyer and a seller that includes use of the best offer feature;

FIG. 5 is a flow chart illustrating an example method of processing an offer made by a buyer for an item listed by a seller;

FIG. 6 is a block diagram illustrating an example user interface that may be presented to a seller of an item when the seller accepts an offer from a prospective buyer for the item;

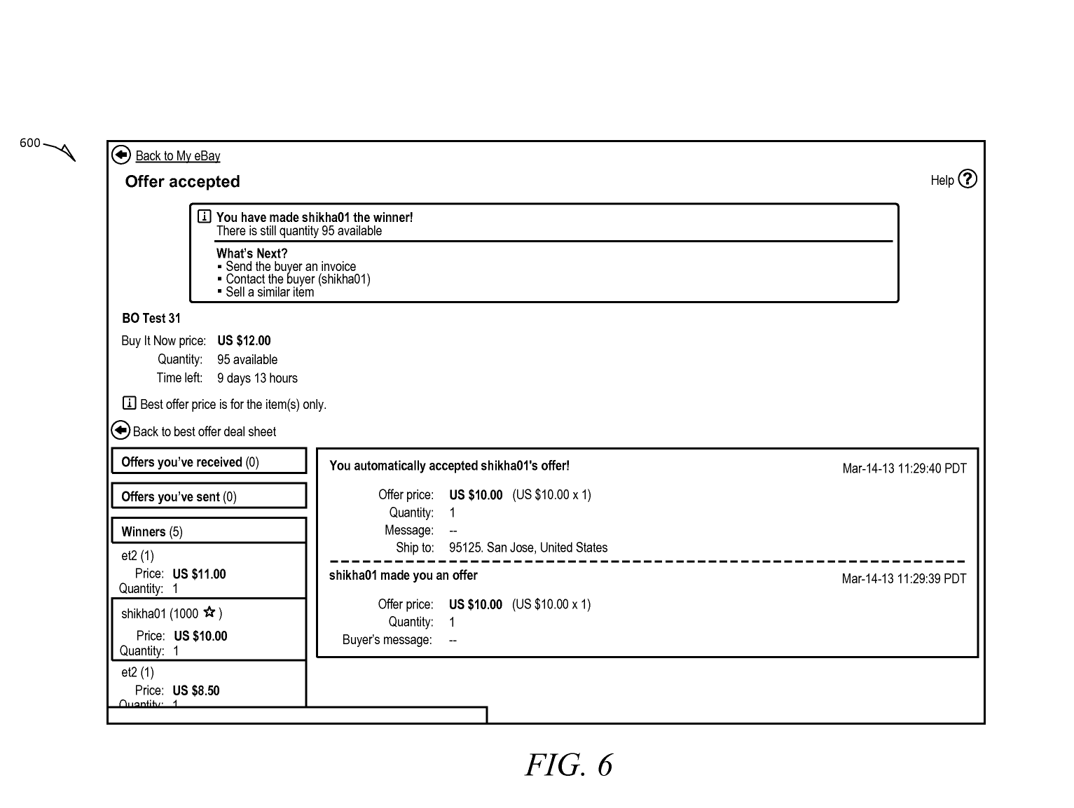

FIG. 7 is a block diagram illustrating an example user interface that may be presented to a seller of an item when the seller makes a counteroffer to a prospective buyer of the item;

FIG. 8 is a block diagram illustrating a series of example user interfaces that may be presented to a prospective buyer of an item when the buyer invokes the best offer feature associated with a listing of the item;

FIG. 9 is a block diagram illustrating a series of example user interfaces that may be presented to a prospective buyer of an item when the seller counters an offer made by the prospective buyer;

FIG. 10 is a block diagram illustrating a series of example user interfaces that may be presented to a prospective buyer of an item when an offer is accepted by a seller or when the prospective buyer accepts a counteroffer by the seller; and

FIG. 11 is a block diagram of machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

Consistent with various embodiments, a method of handling negotiations between a seller of an item and prospective buyers of an item is disclosed. A first offer for the item is received. The first offer includes a first item price and a first item quantity, the first item quantity being less than or equal to an inventory quantity of the seller of the item. The first offer is from a first prospective buyer. A second offer for the item is received. The second offer includes a second item price and a second item quantity, the second item quantity being less or equal to the inventory quantity of the seller of the item. The second offer is received from a second prospective buyer. The sum of the first item quantity and the second item quantity is greater than the inventory quantity of the seller of the item. It is detected that the first prospective buyer submitted a payment corresponding to the first offer before the second prospective buyer submitted a payment corresponding to the second offer. Based on the detecting, the seller of the item is notified that the seller of the item has an obligation to provide the first item quantity of the item to the first prospective buyer and that the seller of the item does not have an obligation to provide the second item quantity of the item to the second prospective buyer.

This method and various embodiments disclosed herein may be implemented as a computer system having one or more modules (e.g., hardware modules or software modules). This method and various embodiments disclosed herein may be embodied as instructions stored on a machine-readable medium that, when executed by a processor, cause the processor to perform the method.

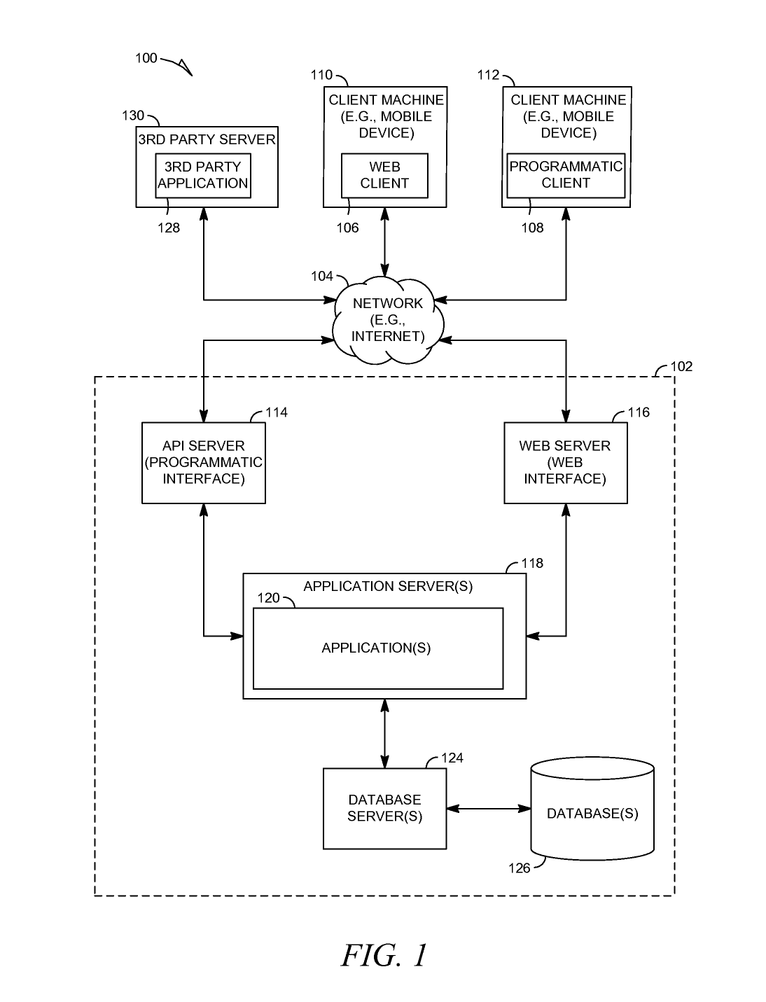

FIG. 1 is a network diagram depicting a system 100 within which various example embodiments may be deployed. A networked system 102, in the example forms of a network-based marketplace or other publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash.) and a programmatic client 108 executing on respective client machines 110 and 112. Each of the one or more clients may include a software application module (e.g., a plug-in, add-in, or macro) that adds a specific service or feature to a larger system. The software application module may be separate from but tightly-integrated into a user interface and functionality of a software application, such as a spreadsheet application. The software application may be a client software application executing on a client machine. The software application module may be optionally deployed in the same environment as the software application such that the software application module can be accessed from within the software application. The software application module may be optionally enabled or disabled within the environment (e.g., user interface) of the software application. The software application module may appear to be a part of the software application by, for example, providing user interface components or widgets (e.g., menus, toolbars, menu commands, toolbar commands, and so on) that can be enabled, disabled, added to, or removed from standard user interface components or widgets provided by the software application.

An API server 114 and a web server 116 are coupled to, and provide programmatic and web interfaces respectively to, one or more application servers 118. The application servers 118 host one or more application(s) 120. The application servers 118 are, in turn, shown to be coupled to one or more database servers 124 that facilitate access to one or more databases 126 or data stores, such as NoSQL or non-relational data stores.

The applications 120 may provide a number of marketplace functions and services to users that access the networked system 102. While the applications 120 are shown in FIG. 1 to form part of the networked system 102, in alternative embodiments, the various applications 120 may form part of a service that is separate and distinct from the networked system 102.

Further, while the system 100 shown in FIG. 1 employs a client-server architecture, various embodiments are, of course, not limited to such an architecture, and could equally well find application in a distributed, or peer-to-peer, architecture system, for example. The various applications 120 could also be implemented as standalone software programs, which do not necessarily have networking capabilities. Additionally, although FIG. 1 depicts machines 130, 110, and 112 as being coupled to a single networked system 102, it will be readily apparent to one skilled in the art that machines 130, 110, and 112, as well as applications 128 and clients 106 and 108, may be coupled to multiple networked systems. For example, the application 128 and clients 106 and 108 may be coupled to applications 120, such as payment applications associated with multiple payment processors (e.g., Visa, MasterCard, and American Express).

The web client 106 accesses the various applications 120 via the web interface supported by the web server 116. Similarly, the programmatic client 108 accesses the various services and functions provided by the applications 120 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third party. The third-party website may, for example, provide one or more promotional, marketplace or payment functions that are supported by the relevant applications of the networked system 102.

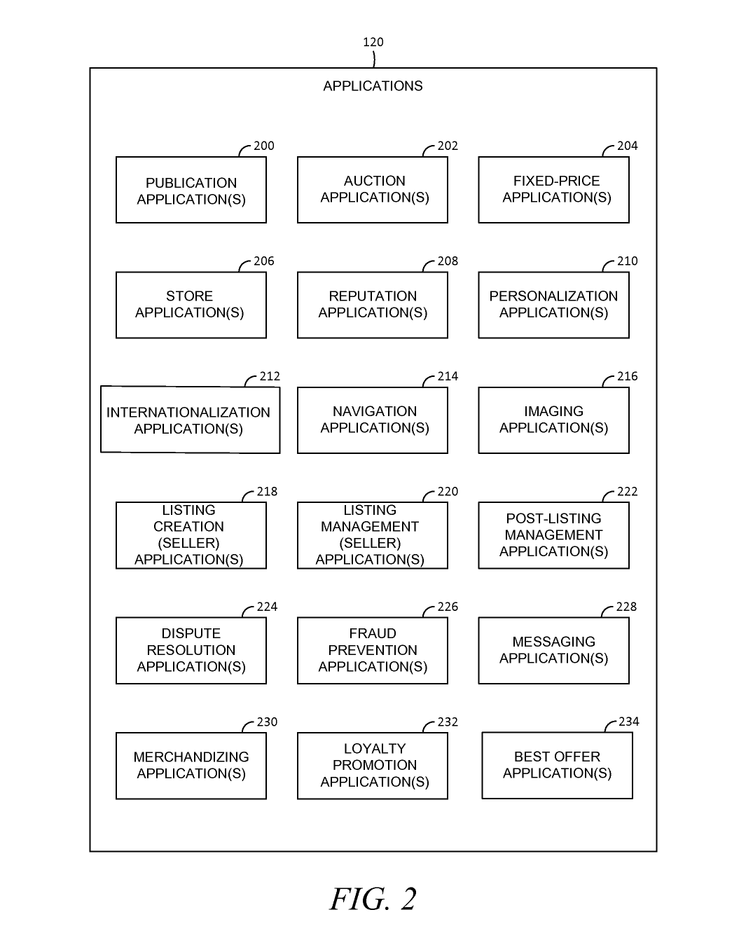

FIG. 2 is a block diagram illustrating multiple applications 120 that, in various example embodiments, are provided as part of the networked system 102. The applications 120 may be hosted on dedicated or shared server machines (not shown) that are communicatively coupled to enable communications between server machines. The applications 120 themselves are communicatively coupled (e.g., via appropriate interfaces) to each other and to various data sources, so as to allow information to be passed between the applications 120 so as to allow the applications 120 to share and access common data. The applications 120 may furthermore access one or more databases 126 via the database servers 124.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable keyword searches of listings published via the networked system 102. A browse application may allow users to browse various category, catalogue, or inventory data structures according to which listings may be classified within the networked system 102. Various other navigation applications may be provided to supplement the search and browsing applications.

In order to make listings available via the networked system 102 as visually informing and attractive as possible, the marketplace applications 120 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. The listing creation application 218 and listing management applications 220 may allow sellers to manage listing in bulk (e.g., in a single operation, such as by an uploading of a file) and provide templates for sellers to manage category-specific, vendor-specific, or general-type-specific (e.g., catalog or ticket) listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of operations in an attempt to settle a dispute. In the event that the dispute cannot be settled via the guided procedures, the dispute may be escalated to a third-party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102. These messages may, for example, advise users regarding the status of listings at the networked system 102 (e.g., providing “outbid” notices to bidders during an auction process or providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotions points for each transaction established and/or concluded with a particular seller, and may be offered a reward for which accumulated loyalty points can be redeemed.

Best offer applications 234, described in more detail below, may allow sellers to entertain offers from buyers even if the offers are less than the seller's asking price for an item as specified in the seller's listing for the item. In various embodiments, a seller may select the option to enable the best offer feature for a particular listing of an item during a creation of the listing for the item. In various embodiments, the seller may specify that offers less than a first price are to be automatically rejected or offers equal to or greater than a second price are to be automatically accepted. In various embodiments, if the seller receives an offer from the buyer that is between the first price and the second price, the seller may review the offer and be provided with options to manually accept or reject the offer, or reply to the buyer with a counter offer.

In various embodiments, a prospective buyer of the item listed by the seller may be notified that the seller has enabled the best offer feature for the listing. For listings for which the best offer feature has been enabled, the buyer may offer to a pay a price for the item that is less than the seller's asking price as specified in the listing of the item. In various embodiments, the buyer may be able to filter for listings of items of a particular type based on whether sellers of the item have enabled the best offer feature for the item. In various embodiments, by enabling the best offer feature for a listing, the seller of a single item may be able to accept multiple offers (e.g., having different prices) from multiple buyers for the single item. Then, the first buyer to pay for the item based on an accepted offer price may receive the item. Thus, multiple buyers having an accepted offer for a single item may have an incentive to act quickly to complete the transaction after it has been approved by the seller. If a second buyer completes a transaction to purchase the item before a first buyer, the first buyer will not receive the item because it may have already gone to the second buyer.

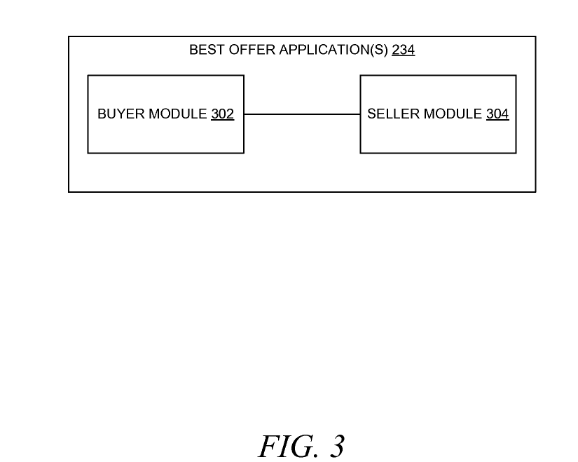

FIG. 3 is a block diagram illustrating example modules of the best offer application(s) 234. A buyer module 302 may receive an offer from a prospective buyer via the best offer feature. The offer may specify different terms for a purchase of the item than the terms that are listed by the seller. For example, the offer may specify a lower item price or a lower quantity than the price and quantity listed by the seller. A seller module 304 may communicate offers made by prospective buyers to the seller. The seller module 304 may also handle automatic or manual acceptance or rejections of the offers. The seller module 304 may further allow a seller to make a counteroffer to a buyer.

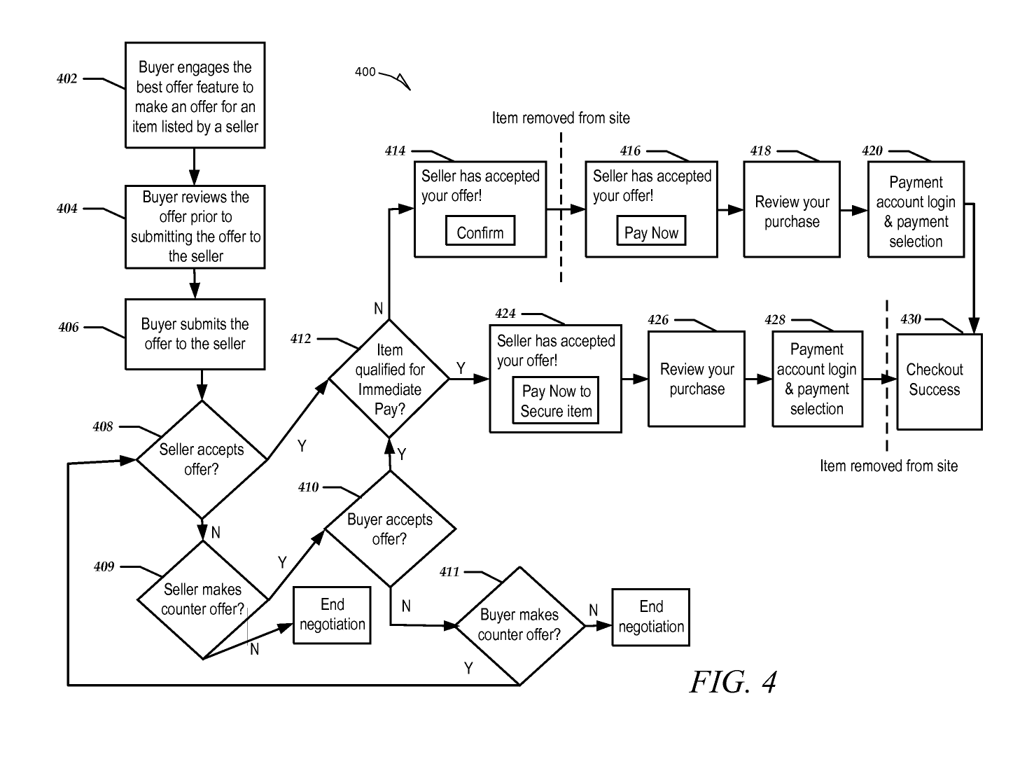

FIG. 4 is a sequence diagram illustrating an example sequence 400 of steps of a transaction initiated on a network-based publication system between a prospective buyer and a seller that includes use of the best offer feature. In various embodiments, various steps of the sequence 400 may be performed by various modules of the best-offer application(s) 234. At operation 402, the buyer module 302 may present a prospective buyer with an option to submit an offer for an item listed by a seller. For example, the buyer module 302 may present the buyer with a best offer page based on the buyer engaging the best offer feature (e.g., by clicking on a user interface element, such as a “Make Offer” button, on a listing page for the item). In various embodiments, the prospective buyer may be provided with the option to engage the best offer feature because the seller has enabled the best offer feature for the listing (e.g., by selecting the best offer option when creating the listing).

The buyer module 302 may then receive an offer for the item from the prospective buyer. For example, the prospective buyer may specify the prospective buyer is willing to pay an amount for the item that is less than a sales price at which the seller has listed the item. The offer may include any combination of an amount for the item, a quantity of the item, terms associated with the offer, an amount that the buyer is willing to pay for shipping, a message submitted by the buyer to persuade the seller to accept the buyer's offer, and so on. For example, the seller may have listed a box of tissues as being for sale for $4.99. The prospective buyer may be willing to purchase the box of tissues for $1.00. In this case, the prospective buyer may engage the best offer feature to make an offer to the seller of $1.00 for the box of tissues. As another example, a prospective buyer may specify that the prospective buyer is willing for the item that is more than a sales price at which the seller has listed the item if certain conditions are met, such as the seller including an extra manual or an extra part with the item, processing or handling the prospective buyer's order more quickly, using particular packaging (e.g., gift wrapping), and so on.

At operation 404, the buyer module 302 may request a prospective to review an offer prior to submitting the offer to the seller. For example, the buyer module 302 may present the prospective buyer with a review page that summarizes the prospective buyer's offer, including an offer amount, quantity, terms associated with the offer, shipping cost, or a message submitted by the buyer to persuade the seller to accept the buyer's offer. In various embodiments, the number of offers that a prospective buyer may make for an item may be limited (e.g., as specified by the seller or a policy of the network-based publication system), and the number of remaining offers that the prospective buyer may make may also be presented to the prospective buyer on the review page. In various embodiments, the number of offers that a prospective buyer may make may vary based on the type of the item that is the subject of the offer. For example, prospective buyers may be limited to making only three offers on items in an electronics category, but limited to making 10 offers on items in a motors category. If, after reviewing the offer, the prospective buyer determines not to make the offer, the prospective buyer may cancel the offer before submitting it to the seller (e.g., by clicking on a user interface element of the review page, such as a “Cancel” button).

At operation 406, the buyer module 302 may receive confirmation from the prospective buyer that the prospective buyer wishes to submit the offer to the seller. For example, the buyer module 302 may be notified that the user clicked a user interface element on the review page, such as a “Submit” button, to submit the offer to the seller.

At operation 408, the seller module 304 may present to the seller the offer submitted by the buyer. For example, the seller module 304 may present the seller with a best offer page that summarizes the offer of the buyer. In various embodiments, the seller may accept or reject the offer made by the prospective buyer. For example, the seller may specify that offers that are greater than a first amount are to be automatically accepted. Or the seller may specify that offers that are less than a second amount are to be automatically rejected. For offers that are in between the first amount and the second amount, the seller may review the offers and manually accept or reject them.

At operation 409, based on the seller rejecting an offer submitted by the prospective buyer, the seller module 304 may present the seller with an option to make a counteroffer. If the seller determines not to make a counteroffer the negotiation between the prospective buyer and the seller ends. However, in some cases (e.g., if the prospective buyer has not submitted more offers for the item than a maximum number of offers that the seller has specified for the item), the prospective buyer may be able to submit a new offer. In this case, the best offer process may begin again at operation 402.

At operation 410, the buyer module 302 may present the buyer with a counter offer of the seller. The buyer module 302 may further determine whether the prospective buyer accepts the counter offer (e.g., based on input from the buyer).

At operation 411, based on the prospective buyer rejecting an offer of the seller, the buyer module 302 may provide the prospective buyer with an option to make a counter offer. In various embodiments, the buyer module 302 may only provide the prospective buyer with the option to make the counter offer if the prospective buyer has not already made a predetermined number of counter offers (e.g., three counter offers). If the buyer elects not to make a counter offer, the negotiations between the seller and the prospective buyer may end.

At operation 412, based on acceptance of an offer (or counter offer) by the seller or an acceptance of an offer (or counter offer) by the buyer, the seller module 304 may determine whether the item qualifies for immediate payment by the buyer. For example, in various embodiments, an item may qualify for immediate payment when an accepted offer price or a listing price of an item is less than a particular amount (e.g., $1000) and when a particular payment method is required by the seller (e.g., a PayPal payment). In various embodiments, if the item qualifies for immediate payment, the process continues at operation 424; otherwise, the process continues at operation 414.

At operation 414, the buyer module 302 may notify the prospective buyer that the seller has accepted the buyer's offer and request a commitment from the prospective buyer to complete the transaction. For example, the buyer module 302 may present a congratulations page to the prospective buyer that prompts the user to accept the offer (e.g., via an “Accept Offer” button). In various embodiments, the seller's listing of the item may not be removed from the network-based publication system until the prospective buyer commits to completing a transaction with the seller for the item based on the accepted terms. Thus, until the prospective buyer makes a commitment to complete the transaction, other prospective buyers may be able to purchase the item immediately (e.g., via a Buy-It-Now option) or submit additional offers for the item (e.g., via additional engagements of the make offer feature associated with the listing).

In various embodiments, if the quantity of the item is depleted by the other transactions to a quantity that is lower than what has been agreed upon between the seller and the buyer, the buyer will not be able to complete the transaction at the agreed-upon terms. Thus, the buyer has an incentive to commit to completing the transaction as quickly as possible. In various embodiments, based on a commitment from the buyer to complete the transaction for the item based on the agreed-upon terms, and based on a determination that a quantity of the item will be reduced to zero after the transaction, the seller module 304 may remove the listing for the item from the network-based publication system.

At operation 416, the buyer module 302 may provide the prospective buyer with an option to submit payment for the item. For example, the buyer module 302 provides the prospective buyer with a purchase page that includes a user interface element (e.g., a “Pay Now” button) via which the prospective buyer may submit the payment.

At operation 418, the buyer module 302 may provide the prospective buyer with options to review, specify, or modify final details pertaining to the order before placing the order, such as the payment method, gift cards, coupons, rewards points, shipping address, and so on. The buyer module 302 may also provide the prospective buyer with a user interface element (e.g., a “Place Order”) button to submit the order after all of the final details have been entered by the buyer.

At operation 420, the buyer module 302 may receive final payment information from the buyer, such as payment account (e.g., PayPal, credit card, etc.) login information or payment selection options. Upon receiving of the final payment information from the buyer, the operations may continue at operation 430.

At operation 424, based on the listing not qualifying for immediate pay, the buyer module 302 presents the prospective buyer with an option to pay for the item to secure the accepted terms of the agreement for the sale of the item. For example, the buyer module 302 presents a “congratulations” page to the prospective buyer, notifying the prospective buyer that the seller has accepted the buyer's offer. The congratulations page may also notify the prospective buyer that the prospective buyer may not be able to complete the agreed-upon transaction unless the prospective buyer pays for the item before any other prospective buyers that have also had offers accepted by the seller.

For example, in various embodiments, the prospective buyer may be notified that the seller may have accepted offers from multiple buyers for a quantity of the item that is more than the quantity that the seller has for sale. Thus, only a subset of the prospective buyers (the ones who pay first) may be able to actually complete the agreed-upon transaction with the seller. Thus, the prospective buyers who have had their offers accepted by the seller may have an incentive to submit a payment to secure a quantity of the item before other prospective buyers submit payments to secure other quantities of the item.

At operation 426, the buyer module 302 may provide the prospective buyer with options to review, specify, or modify final details pertaining to the order before placing the order, as described above with respect to operation 418.

At operation 428, the buyer module 302 may receive final payment information from the buyer, such as payment account login information or payment selection options.

At operation 430, the buyer module 302 notifies the buyer or seller of a successful completion of payment for the item. In various embodiments, the notification may be based on a communication from a payment system (e.g., a PayPal or credit card system) that the payment was processed successfully.

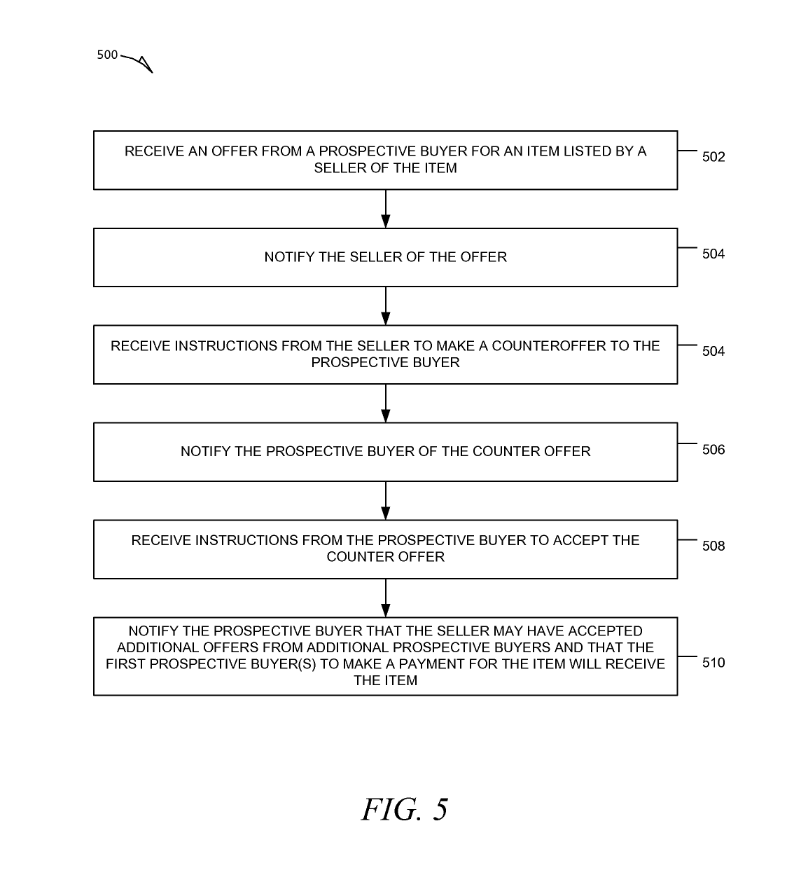

FIG. 5 is a flow chart illustrating an example method 500 of processing an offer made by a buyer for an item listed by a seller. In various embodiments, various operations of the method 500 may be performed by various modules of the best-offer application(s) 234.

At operation 502, the seller module 304 may receive an offer from a prospective buyer for an item listed by a seller of the item. In various embodiments, the offer is received via a best offer feature that the seller has enabled for the listing of the item, as described above. Thus, the offer may be for less than an asking price specified in the listing of the item. Or the offer may specify a lower quantity, lower shipping price, or other terms that are different than the terms specified by the seller in the listing for the item.

At operation 504, the seller module 304 may notify the seller of the offer. In various embodiments, the seller module 304 notifies the seller only if the offer is more attractive than a minimum offer that the seller has specified should be automatically rejected (e.g., if the has a higher price, larger quantity, higher shipping price, or other combination of terms than a minimum specified by the seller) and if the offer is less attractive than a minimum offer that the seller has specified should be automatically accepted. In other words, in various embodiments, the seller is only notified of the offer of the seller if the offer falls in a gray area in which the seller wishes to manually consider the offer.

At operation 504, the seller module 304 may receive instructions from the seller to make a counteroffer to the prospective buyer. For example, the seller may specify that the seller will accept an offer having slightly different terms (e.g., sales price, quantity, shipping price, or other terms) than what the prospective buyer has proposed.

At operation 506, the buyer module 302 may notify the prospective buyer of the counter offer. For example, the buyer module 302 may present a counter offer page to the prospective buyer that summarizes the terms of the counter offer made by the seller.

At operation 508, the buyer module 302 may receive instructions from the prospective buyer to accept the counter offer.

At operation 510, based on the acceptance of the counter offer by the prospective buyer, the buyer module 302 may notify the prospective buyer that, although the buyer has accepted the counteroffer made by the seller, the prospective buyer must still make a payment for the item quickly in order to secure the item. For example, the buyer module 302 may notify the prospective buyer that the seller may have also accepted additional offers from additional prospective buyers and that the first of the prospective buyers to make payments for the item will receive the item. Thus, if the seller has accepted offers from 10 buyers for a total quantity of 100 items, but only has 50 items in stock, the only buyers who will actually be able to complete the transaction are the first buyers who make payment before the seller's supply of the item is exhausted.

In various embodiments, if the seller's supply of the item is exhausted before the prospective buyer makes payment for the item, the buyer module 302 may notify the prospective buyer that the seller's supply has been exhausted by other buyers who made their payments faster than the prospective buyer.

FIG. is a block diagram illustrating an example user interface 600 that may be presented to a seller of an item when the seller accepts an offer from a prospective buyer for the item. In various embodiments, the seller module 306 may present the user interface 600 to the seller when the seller accesses an administration area of the network-based publication system. In various embodiments, the user interface 600 specifies the user name of the buyer and the terms of the offer (e.g., item price, quantity, shipping price, and so on) that was accepted. In various embodiments, the user interface 600 specifies the asking price (e.g., Buy It Now price) for the item, a remaining quantity of the item, and an amount of time before the listing for the item is to expire. In various embodiments, the user interface 600 includes information pertaining to offers the seller has received, offers that the seller has sent (e.g., counteroffers), winners (e.g., users that have made offers that the seller has accepted), and so on. The user interface 600 may also include a history of transactions, including the dates at which offers were received and accepted. The user interface 600 may also include information about the buyers that the seller needs to complete the transactions with the buyers, such as their shipping addresses, and so on.

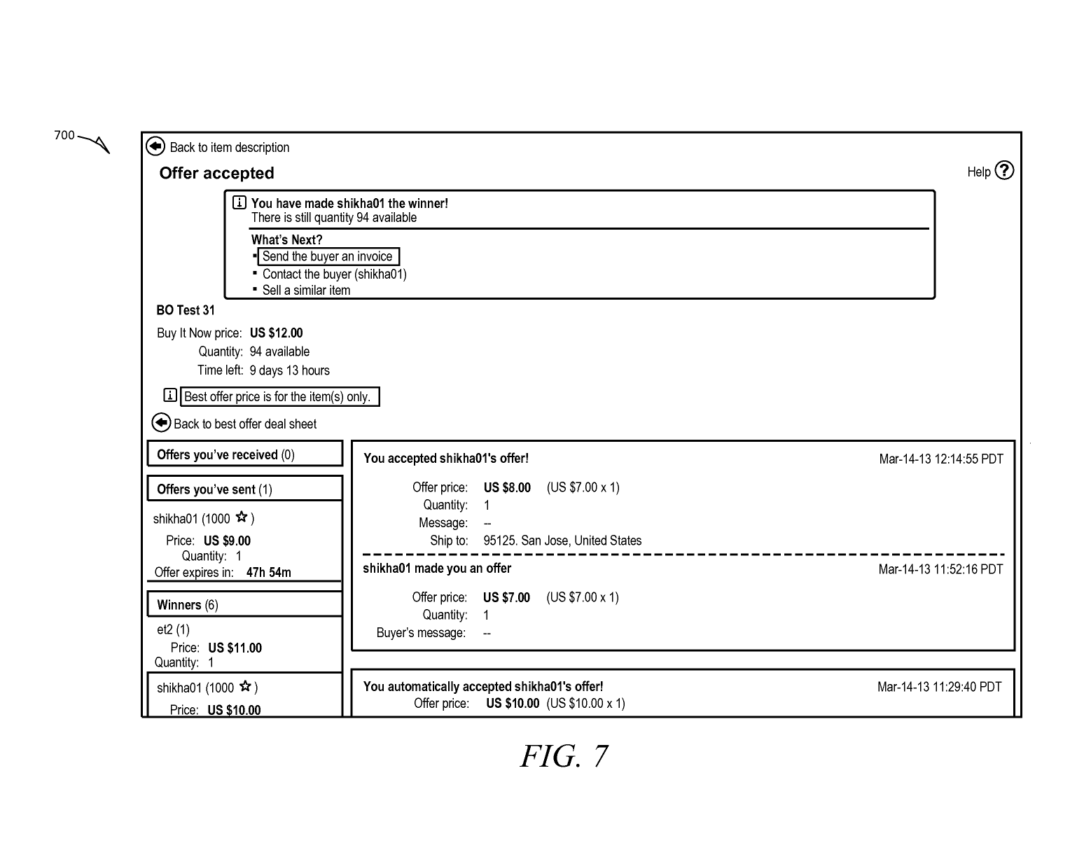

FIG. 7 is a block diagram illustrating an example user interface 700 that may be presented to a seller of an item when the seller makes a counteroffer to a prospective buyer of the item. In various embodiments, the seller module 304 may present the user interface 700 to the seller when the seller accesses an administration area of the network-based publication system. In various embodiments, the user interface 700 specifies the user name of the buyer and the terms of the offer (e.g., item price, quantity, shipping price, and so on). The user interface 700 may specify the asking price (e.g., Buy It Now price) for the item, a remaining quantity of the item, and an amount of time before the listing for the item is to expire. In various embodiments, the user interface 700 includes information pertaining to offers the seller has received that were not automatically accepted or rejected by the seller (e.g., based on rules specified by the seller). In various embodiments, the user interface 700 provides a mechanism (e.g., an input screen) through which the seller may provide a counteroffer to a prospective buyer. In various embodiments, the user interface 700 provides a mechanism (e.g., accept or reject buttons) through which the seller may manually accept or reject an offer. Thus, the user interface 700 may present a record of offers that have been received, counteroffers, automatically accepted offers, manually accepted offers, and so on.

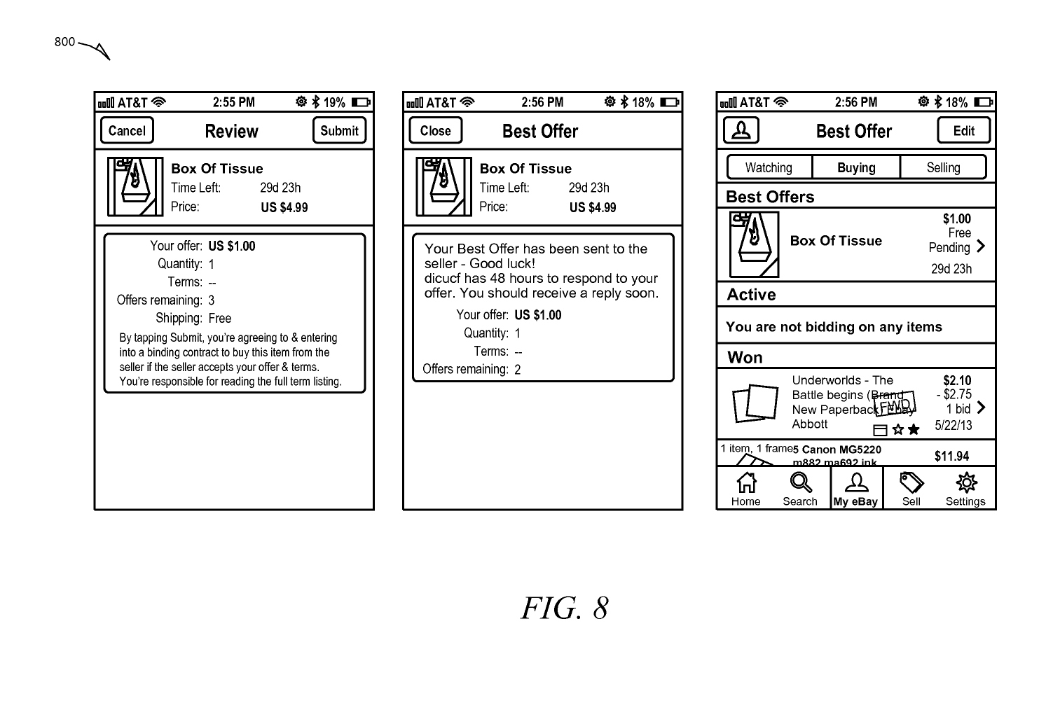

FIG. 8 is a block diagram illustrating a series of example user interfaces 800 that may be presented to a prospective buyer of an item when the buyer invokes the best offer feature associated with a listing of the item. In various embodiments, the buyer module 306 may present the first of the series of user interfaces 800 to the seller when the buyer clicks a “Make Offer” button associated with the listing and specifies an offer. The first of the series of user interfaces 800 may present a summary of the offer to the prospective buyer and provide the prospective buyer with options to submit the offer to the seller or cancel the offer. The second of the series of user interfaces 800 may notify the prospective buyer that the offer has been submitted to the seller. The third of the series of user interfaces 800 may present a list of items for which the prospective buyer has made offers, as well as the status of each offer (e.g., “accepted,” “rejected,” “countered,” or “pending”).

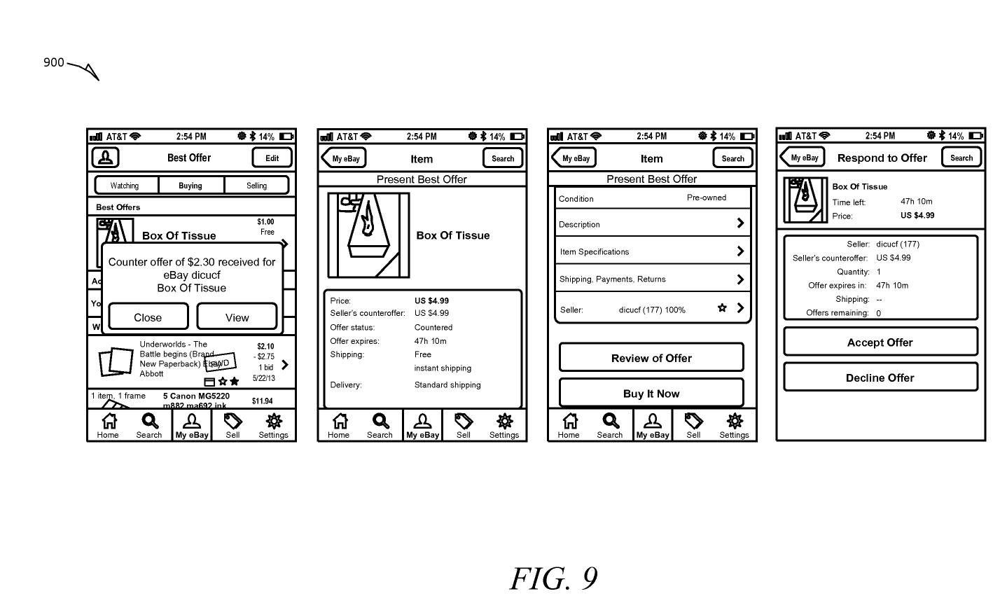

FIG. 9 is a block diagram illustrating aseries of user interfaces 900 that may be presented to a prospective buyer of an item when the seller counters an offer made by the prospective buyer. In various embodiments, the buyer module 302 may present the first of the series of user interfaces 900 to the seller when the prospective buyer accesses the network-based publication system after the seller has submitted a counter offer. The first of the series of user interfaces 900 may present a subset of information about the counteroffer (e.g., a proposed item price) to the prospective buyer and provide the prospective buyer with an option to view more information about the counter offer. The second of the series of user interfaces 900 may present additional terms of the counter offer, such as the item amount, item quantity, shipping amount, expiration date of the offer, delivery method, and so on. The third of the series of user interfaces 900 may present the listing for the item. However, based on the the seller having made a counter offer, the “Make Offer” button at the bottom of the item page is replaced with a “Review Offer” button. The fourth of the series of user interfaces 900 may present the prospective buyer with options to either accept or decline the counter offer made by the seller.

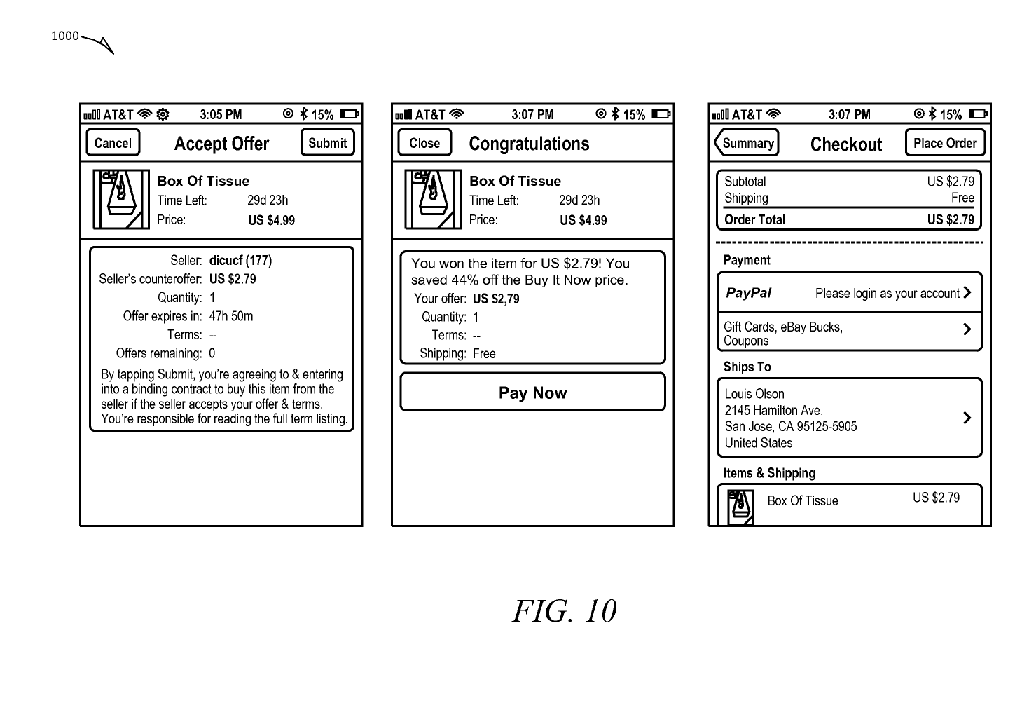

FIG. 10 is a block diagram illustrating a series of user interfaces 1000 that may be presented to a prospective buyer of an item when an offer is accepted by a seller or when the prospective buyer accepts a counteroffer by the seller. In various embodiments, the buyer module 302 presents the series of user interfaces to the prospective buyer. In the first of the series of user interfaces 1000, the seller may be presented with a summary of the terms of the offer that the prospective buyer may accept. Based on the user accepting the offer, the second of the series of user interfaces 1000 may be presented, congratulating the prospective buyer for accepting the offer. Although not depicted in FIG. 10, the second of the series of user interfaces 1000 may also specify that the prospective buyer must pay for the item before the agreed-upon quantity of the item has been exhausted by the seller in fulfillment of other offers that the seller has accepted. Thus, the prospective buyer may be placed on notice that mere acceptance of the offer may not guarantee that the prospective buyer will receive the item. The third of the series of user interfaces 1000 may be presented to the prospective buyer based on the prospective buyer indicating an intent to pay the negotiated price for the item. The third of the series of user interfaces 1000 may include final details pertaining to the order, including payment method and so on. By paying for the item before other prospective buyers pay for their orders, the prospective buyer may ensure that the seller is obligated to complete the transaction based on the negotiated terms.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

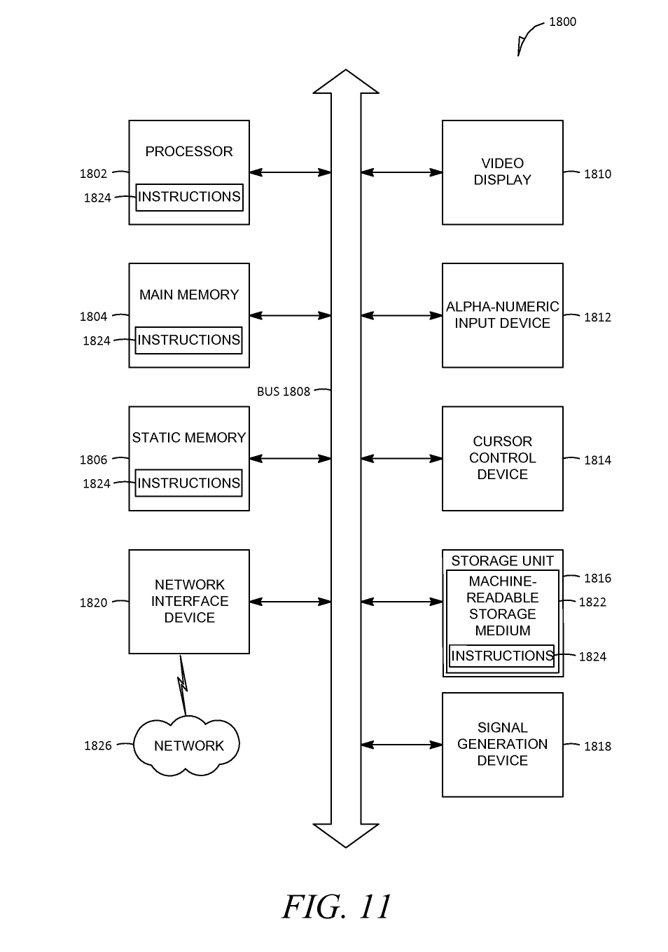

FIG. 11 is a block diagram of machine in the example form of a computer system 1800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a user interface (UI) navigation (or cursor control) device 1814 (e.g., a mouse), a storage unit 1816, a signal generation device 1818 (e.g., a speaker) and a network interface device 1820.

The storage unit 1816 includes a machine-readable medium 1822 on which is stored one or more sets of data structures and instructions 1824 (e.g., software) embodying or utilized by any one or more of the methodologies or functions described herein. The instructions 1824 may also reside, completely or at least partially, within the main memory 1804 and/or within the processor 1802 during execution thereof by the computer system 1800, the main memory 1804 and the processor 1802 also constituting machine-readable media. The instructions 1824 may also reside, completely or at least partially, within the static memory 1806.

While the machine-readable medium 1822 is shown in an example embodiment to be a single medium, the term “machine-readable medium” may include a single medium or multiple media (e.g., a centralized or distributed database, and/or associated caches and servers) that store the one or more instructions 1824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 1824 may further be transmitted or received over a communications network 1826 using a transmission medium. The instructions 1824 may be transmitted using the network interface device 1820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1826 may be one of the networks 104.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving a first offer for an item, the first offer including a first item price and a first item quantity, the first item quantity being less than or equal to an inventory quantity of a seller of the item, the first offer being from a first prospective buyer;
receiving a second offer for the item, the second offer including a second item price and a second item quantity, the second offer being from a second prospective buyer, the second item quantity being less than or equal to the inventory quantity of the seller of the item, the sum of the first item quantity and the second item quantity being greater than the inventory quantity of the seller of the item; and
based on a detecting that the first prospective buyer submitted a payment corresponding to the first offer before the second prospective buyer submitted a payment corresponding to the second offer, notifying the seller of the item that the seller of the item has an obligation to provide the first item quantity of the item to the first prospective buyer and that the seller of the item does not have an obligation to provide the second item quantity of the item to the second prospective buyer, the notifying being performed by a processor.

2. The method of claim 1, further comprising:
notifying the first prospective buyer of a conditional acceptance by the seller of the first offer, the conditional acceptance by the seller of the first offer to become an acceptance by the seller of the first offer based on the first prospective buyer submitting the payment corresponding to the first offer before the second prospective buyer submits the payment corresponding to the second offer; and
notifying the second prospective buyer of a conditional acceptance by the seller of the second offer, the conditional acceptance by the seller of the second offer to become an acceptance by the seller of the second offer based on the second prospective buyer submitting the payment corresponding to the second offer before the first prospective buyer submits the payment corresponding to the first offer.

3. The method of claim 1, further comprising notifying the second prospective buyer that the seller does not have the obligation to provide the second item quantity of the item to the second prospective buyer based on the first prospective buyer submitting the payment corresponding to the first offer before the second prospective buyer submitting the payment corresponding to the second offer.

4. The method of claim 1, further comprising notifying the first prospective buyer that the seller does have the obligation to provide the first item quantity of the item to the first prospective buyer based on the first prospective buyer submitting the payment corresponding to the first offer before the second prospective buyer submitting the payment corresponding to the second offer.

5. The method of claim 1, further comprising notifying the first prospective buyer of an automatic acceptance of the first offer by the seller of the item based on terms of the offer exceeding minimum terms specified by the seller.

6. The method of claim 1, further comprising notifying the seller of the item of the first offer based on the terms of the first offer being below terms specified by the seller for automatic acceptance of the first offer and being above terms specified by the seller for automatic rejection of the offer.

7. The method of claim 1, further comprising removing a listing corresponding to the item based on the first quantity being equal to the inventory quantity of the seller and the detecting that the first prospective buyer submitted the payment corresponding to the first offer.

8. A system comprising:
at least one hardware processor;
at least one module implemented by the at least one hardware processor and configured to:
receive a first offer for an item, the first offer including a first item price and a first item quantity, the first item quantity being less than or equal to an inventory quantity of a seller of the item, the first offer being from a first prospective buyer;
receive a second offer for the item, the second offer including a second item price and a second item quantity, the second offer being from a second prospective buyer, the second item quantity being less than or equal to the inventory quantity of the seller of the item, the sum of the first item quantity and the second item quantity being greater than the inventory quantity of the seller of the item; and
based on a detecting that the first prospective buyer submitted a payment corresponding to the first offer before the second prospective buyer submitted a payment corresponding to the second offer, notify the seller of the item that the seller of the item has an obligation to provide the first item quantity of the item to the first prospective buyer and that the seller of the item does not have an obligation to provide the second item quantity of the item to the second prospective buyer.

9. The system of claim 8, the at least one module further configured to:
notify the first prospective buyer of a conditional acceptance by the seller of the first offer, the conditional acceptance by the seller of the first offer to become an acceptance by the seller of the first offer based on the first prospective buyer submitting the payment corresponding to the first offer before the second prospective buyer submits the payment corresponding to the second offer; and
notify the second prospective buyer of a conditional acceptance by the seller of the second offer, the conditional acceptance by the seller of the second offer to become an acceptance by the seller of the second offer based on the second prospective buyer submitting the payment corresponding to the second offer before the first prospective buyer submits the payment corresponding to the first offer.

10. The system of claim 8, the at least one module further configured to notify the second prospective buyer that the seller does not have the obligation to provide the second item quantity of the item to the second prospective buyer based on the first prospective buyer submitting the payment corresponding to the first offer before the second prospective buyer submitting the payment corresponding to the second offer.

11. The system of claim 8, the at least one module further configured to notify the first prospective buyer that the seller does have the obligation to provide the first item quantity of the item to the first prospective buyer for based on the first prospective buyer submitting the payment corresponding to the first offer before the second prospective buyer submitting the payment corresponding to the second offer.

12. The system of claim 8, the at least one module further configured to notify the first prospective buyer of an automatic acceptance of the first offer by the seller of the item based on terms of the offer exceeding minimum terms specified by the seller.

13. The system of claim 8, the at least one module further configured to notify the seller of the item of the first offer based on the terms of the first offer being below terms specified by the seller for automatic acceptance of the first offer and being above terms specified by the seller for automatic rejection of the offer.

14. The system of claim 8, the at least one module further configured to remove a listing corresponding to the item based on the first quantity being equal to the inventory quantity of the seller and the detecting that the first prospective buyer submitted the payment corresponding to the first offer.

15. A non-transitory machine readable medium embodying a set of instructions that, when executed by a processor, causes the processor to perform operations comprising:
receiving a first offer for an item, the first offer including a first item price and a first item quantity, the first item quantity being less than or equal to an inventory quantity of a seller of the item, the first offer being from a first prospective buyer;
receiving a second offer for the item, the second offer including a second item price and a second item quantity, the second offer being from a second prospective buyer, the second item quantity being less than or equal to the inventory quantity of the seller of the item, the sum of the first item quantity and the second item quantity being greater than the inventory quantity of the seller of the item; and
based on a detecting that the first prospective buyer submitted a payment corresponding to the first offer before the second prospective buyer submitted a payment corresponding to the second offer, notifying the seller of the item that the seller of the item has an obligation to provide the first item quantity of the item to the first prospective buyer and that the seller of the item does not have an obligation to provide the second item quantity of the item to the second prospective buyer.

16. The non-transitory machine readable medium of claim 15, the operations further comprising:
notifying the first prospective buyer of a conditional acceptance by the seller of the first offer, the conditional acceptance by the seller of the first offer to become an acceptance by the seller of the first offer based on the first prospective buyer submitting the payment corresponding to the first offer before the second prospective buyer submits the payment corresponding to the second offer; and
notifying the second prospective buyer of a conditional acceptance by the seller of the second offer, the conditional acceptance by the seller of the second offer to become an acceptance by the seller of the second offer based on the second prospective buyer submitting the payment corresponding to the second offer before the first prospective buyer submits the payment corresponding to the first offer.

17. The non-transitory machine readable medium of claim 15, the operations further comprising notifying the second prospective that the seller does not have the obligation to provide the second item quantity of the item to the second prospective buyer for the reason that the first prospective buyer submitted the payment corresponding to the first offer before the second prospective buyer submitted the payment corresponding to the second offer.

18. The non-transitory machine readable medium of claim 15, the operations further comprising notifying the first prospective that the seller does have the obligation to provide the first item quantity of the item to the first prospective buyer for the reason that the first prospective buyer submitted the payment corresponding to the first offer before the second prospective buyer submitted the payment corresponding to the second offer.

19. The non-transitory machine readable medium of claim 15, the operations further comprising notifying the first prospective buyer of an automatic acceptance of the first offer by the seller of the item based on terms of the offer exceeding minimum terms specified by the seller.

20. The non-transitory machine readable medium of claim 15, the operations further comprising notifying the seller of the item of the first offer based on the terms of the first offer being below terms specified by the seller for automatic acceptance of the first offer and being above terms specified by the seller for automatic rejection of the offer.
